(19) United States
(12) Patent Application Publication
(10) Pub. No.: US 2014/0129576 A1
(43) Pub. Date: May 8, 2014

(54) ANALYSIS OF MEETING CONTENT AND AGENDAS

(71) Applicant: INTERNATIONAL BUSINESS MACHINES CORP, Armonk, NY (US)

(72) Inventors: Judith H. Bank, Morrisville, NC (US); Lisa M. Bradley, Cary, NC (US); Lin Sun, Morrisville, NC (US)

(73) Assignee: INTERNATIONAL BUSINESS MACHINES CORPORATION, Armonk, NY (US)

(21) Appl. No.: 13/670,780

(22) Filed: Nov. 7, 2012

(51) Int. Cl. G06F 17/30

(52) U.S. Cl. 707/758; 707/E17.005

(57) ABSTRACT

A method, computer program product, and computer system for analysis of meeting content and agendas. A computer system receives meeting information of a first meeting. The computer system searches one or more second meetings matching the first meeting. The computer system retrieves meeting information of the one or more second meetings. The computer system acquires presentation documents of the first meeting and the one or more second meetings. The computer system analyzes the meeting information and presentation documents for the first meeting and the one or more second meetings. The computer system presents a comparison between the first meeting and the one or more second meetings.

### FIELD OF THE INVENTION

The present invention relates generally to social analytics using computer systems, and more particularly to analysis of meeting content and agendas by computer systems.

### BACKGROUND

Management of informative meetings includes generating agendas and scheduling informative subjects and presentations. Often, content of a presentation is duplicated at one or more meetings due to poor management of the meetings (e.g. due to improperly generated agendas or improperly scheduled subjects and/or presentation titles). Thus, people attending the meetings may find that they have attended previous meetings with similar agendas, subjects, or presentations.

One method of meeting management is to select participants for a meeting based on comparison between profiles of the participation candidates and meeting topic keywords, and next to determine whether the participation candidates are invited to a current meeting or a future meeting. Another method allows for the detection of similar multiple events using event characteristics and the consolidation of similar multiple events into a new event with an adjusted schedule.

### SUMMARY

Embodiments of the present invention provide a method, computer program product, and computer system for analysis of meeting content and agendas. A computer system receives meeting information of a first meeting. The computer system searches one or more second meetings matching the first meeting. The computer system retrieves meeting information of the one or more second meetings. The computer system analyzes the meeting information of the first meeting and the meeting information of the one or more second meetings. The computer system acquires one or more presentation documents of the first meeting and one or more presentation documents of the one or more second meetings. The computer system analyzes the one or more presentation documents of the first meeting and the one or more presentation documents of the one or more second meetings. And, the computer system presents comparison between the first meeting and the one or more second meetings.

### BRIEF DESCRIPTION OF THE SEVERAL VIEWS OF THE DRAWINGS

FIG. 1 is a diagram illustrating a meeting content and agenda analysis system, in accordance with an exemplary embodiment of the present invention.

FIG. 2 is a flowchart illustrating operational steps of analysis of meeting content and agendas, in accordance with an exemplary embodiment of the present invention.

FIG. 3 is a flowchart illustrating a first example of analysis of meeting content and agendas, in accordance with an exemplary embodiment of the present invention.

FIG. 4 is a flowchart illustrating a second example of analysis of meeting content and agendas, in accordance with an exemplary embodiment of the present invention.

FIG. 5 is a flowchart illustrating a third example of analysis of meeting content and agendas, in accordance with an exemplary embodiment of the present invention.

FIG. 6 is a diagram illustrating components of a computer device hosting the meeting content and agenda analysis system shown in FIG. 1, in accordance with an exemplary embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

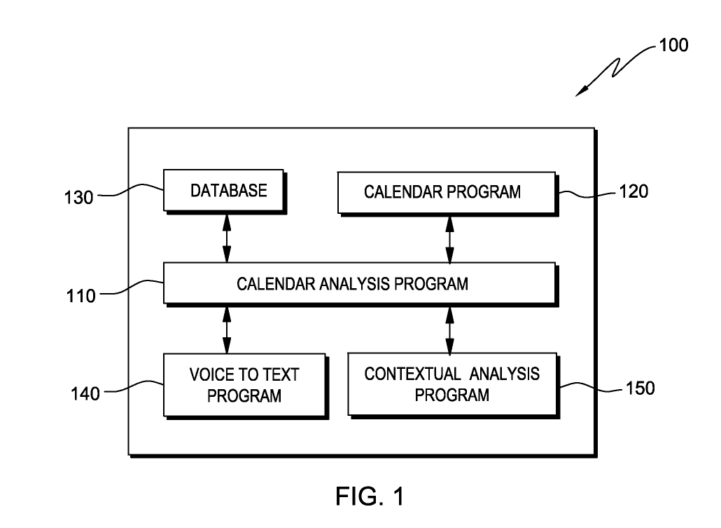

FIG. 1 is a diagram illustrating meeting content and agenda analysis system 100, in accordance with an exemplary embodiment of the present invention. Meeting content and agenda analysis system 100 includes calendar analysis program 110, calendar program 120, database 130, voice to text program 140, and contextual analysis program 150. Calendar program 120 is a calendar and day planner program which has entries of meetings. Database 130 is a database for storing meeting information (e.g. agendas) and documents (e.g. presentation files at the meetings). Calendar analysis program 110 is for analysis of the meeting information and meeting documents. Calendar analysis program 110 searches entries of calendar program 120 and/or database 130 to find one or more previous meetings. Calendar analysis program 110 retrieves from database 130 the meeting information and documents. Calendar analysis program 110 analyzes the meeting information and documents of a current meeting and the one or more previous meetings. Calendar analysis program 110 presents to a user results of the analysis and comparison between the current meeting and the one or more previous meetings. Calendar analysis program 110 receives from a user changes to the current meeting and then makes the changes on calendar program 120. When analyzing voice recordings of meeting presentations, calendar analysis program 110 uses voice-to-text program 140. Voice-to-text program 140 converts the voice recordings to text documents. When the text documents are compared, calendar analysis program 110 uses contextual analysis program 150.

In the exemplary embodiment, meeting content and agenda analysis system 100 is hosted by a computer device. In other embodiments, components of meeting content and agenda analysis system 100, namely calendar analysis program 110, calendar program 120, database 130, voice to text program 140, and contextual analysis program 150, may be separately hosted by multiple computer devices which are connected by a network.

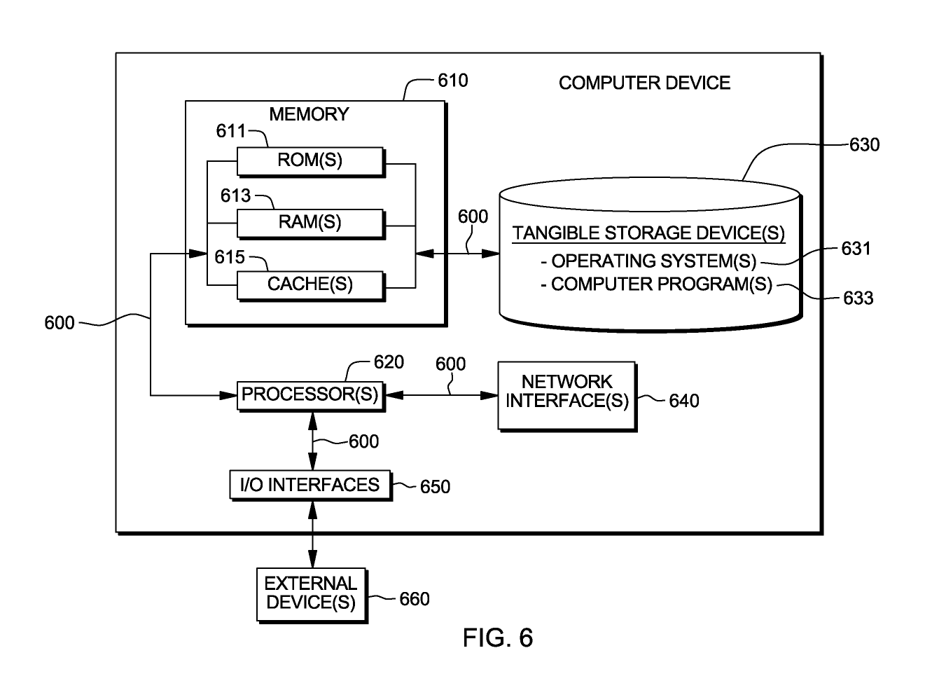

In the exemplary embodiment, the computer device hosting meeting content and agenda analysis system 100 may be a desktop computer, a notebook computer, a laptop computer, a tablet computer, a handheld device, a smartphone, a thin client, or any other electronic device or computing system capable of receiving input from a user, executing computer program instructions. An exemplary computer device hosting meeting content and agenda analysis system 100 is described in more detail in later paragraphs with reference to FIG. 6, in accordance with an exemplary embodiment of the present invention.

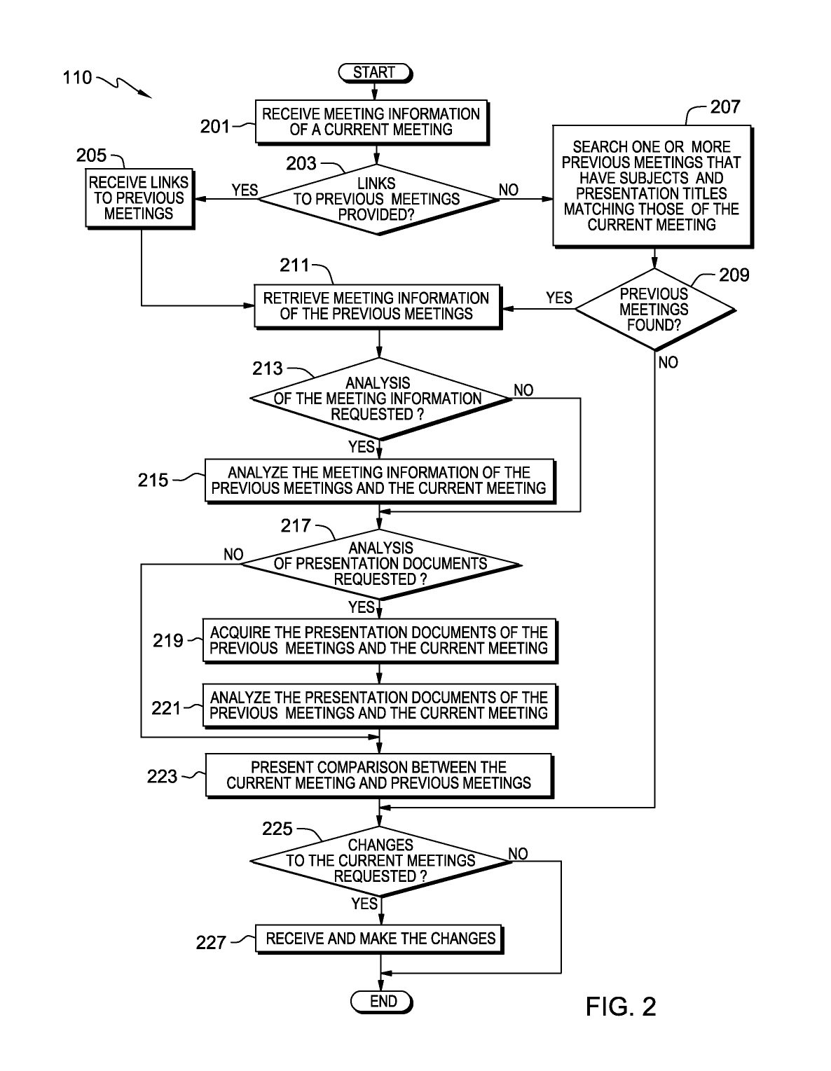

FIG. 2 is a flowchart illustrating operational steps of analysis of meeting content and agendas, in accordance with an exemplary embodiment of the present invention. The operational steps of analysis of meeting content and agendas are implemented by calendar analysis program 110 shown in FIG. 1. Referring to FIG. 2, at step 201, calendar analysis program 110 receives meeting information of a current meeting, e.g. an agenda of the current meeting. Calendar analysis program 110 may retrieve the meeting information of the current meeting from calendar program 120 or database 130 (shown in FIG. 1), or may receive from input by a user. The meeting information of the current meeting, e.g. the agenda of the current meeting, may include a subject, a presentation title, a speaker of the presentation title, and an invitee list of the current meeting. At decision block 203, calendar analysis program 110 makes a decision based on whether a user provides links to one or more previous meetings. In response to that the user provides the links of the one or more previous meetings (YES branch of decision block 203), at step 205, calendar analysis program 110 receives, from the user, the links to the one or more previous meetings.

In response to that the user does not input the links to the one or more previous meetings (NO branch of decision block 203), at step 207, calendar analysis program 110 searches, through searching entries of calendar program 120 and/or database 130, the one or more previous meetings that have subjects and presentation titles matching those of the current meeting. For example, searching the subjects and the presentation titles is conducted through searching keywords in the subject, the presentation title, or the presentation content of the current meeting and the one or more previous meetings. At decision block 209, calendar analysis program 110 determines whether the one or more previous meetings are found.

In response to that the one or more previous meetings are found (YES branch of decision block 209) or after receiving the links to the one or more previous meetings at step 205, at step 211, calendar analysis program 110 retrieves, from either calendar program 120 and/or database 130, the meeting information of the one or more previous meetings. The meeting information of the one or more previous meetings, e.g. agendas of the one or more previous meetings, may include subjects, presentation titles, speakers of the presentation titles, and attendee lists of the one or more previous meetings.

At decision block 213, calendar analysis program 110 makes a decision based on whether analysis of the meeting information of the one or more previous meetings and the current meeting is requested by a user. In response to that the user requests the analysis (YES branch of decision block 213), at step 215, calendar analysis program 110 analyzes the meeting information of the one or more previous meetings and the current meeting. For example, calendar analysis program 110 compares the invitee list of the current meeting with the attendee lists of the one or more previous meetings, and further determines how many invitees and/or what percentage of invitees of the current meeting are in the attendee lists of the one or more previous meetings and have already viewed presentations matching the presentation of the current meeting.

In response to that the user does not request the analysis (NO branch of decision block 213) or after step 215, calendar analysis program 110, at decision block 217, makes a decision based on whether analysis of presentation documents of the one or more previous meetings and the current meeting is requested by a user. In response to that the analysis of the presentation documents is requested by the user (YES branch of decision block 217), at step 219, calendar analysis program 110 acquires the presentation documents of the one or more previous meetings and the current meeting. Calendar analysis program 110 may retrieve the presentation documents stored on database 130 or other file storage systems. Calendar analysis program 110 may also request the user to input or upload the presentation documents. The presentation documents include text files, video files, audio files, charts, and other contents.

Referring to FIG. 2, at step 221, calendar analysis program 110 analyzes the presentation documents acquired at step 219. For example, in the analysis of the presentation documents, calendar analysis program 110 compares presentation documents of the current meeting with presentation documents of the one or more previous meetings. Through the comparison, calendar analysis program 110 determines differences and/or similarities between the presentation documents of the one or more previous meetings and the presentation documents of the current meeting. To analyze voice recordings in audio files or video files, calendar analysis program 110 uses voice to text program 140 (shown in FIG. 1). In analysis of text files, calendar analysis program 110 uses contextual analysis program 150 (shown in FIG. 1).

After step 221 or in response to that the analysis of the presentation documents is not requested by the user (NO branch of decision block 217), at step 223, calendar analysis program 110 presents comparison between the current meeting and the one or more previous meetings. For example, calendar analysis program 110 presents the comparison of the agendas of the current meeting and the one or more previous meetings, and calendar analysis program 110 presents analysis results for both the meeting information and the presentation documents if the analysis is conducted at step 215 or step 221.

After step 223 or in response to that the one or more previous meetings are not found (NO branch of decision block 209), calendar analysis program 110, at decision block 225, makes a decision based on whether the user requests changes to the current meeting. In response to that the user requests the changes (YES branch of decision block 225), calendar analysis program 110, at step 227, receives the changes from the user and makes the change on calendar program 120. In response to that the user does not request changes to the current meeting (NO branch of decision block 225), calendar analysis program 110 terminates the operation. In other embodiments, after step 227, calendar analysis program 110 may call one or more programs for editing presentation documents of the current meeting.

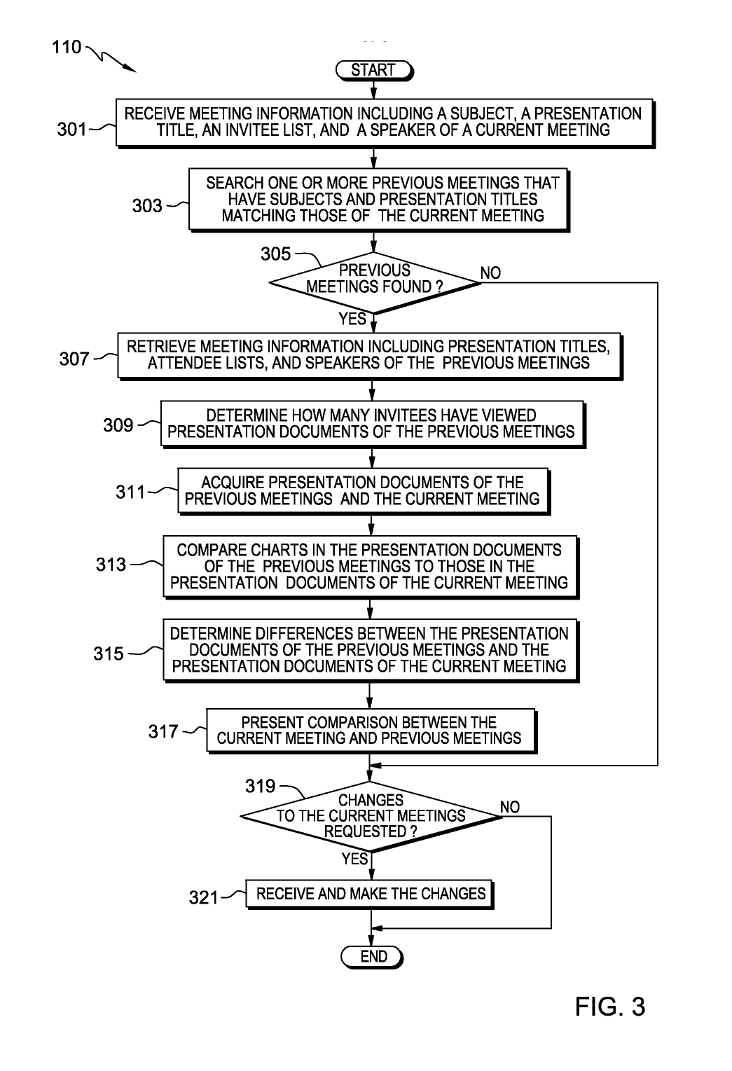

FIG. 3 is a flowchart illustrating a first example of analysis of meeting content and agendas, in accordance with an exemplary embodiment of the present invention. In the first example, calendar analysis program 110 is used by an organizer or a chairperson of a current meeting. At step 301, calendar analysis program 110 receives, from the organizer or the chairperson, meeting information which includes a subject, a presentation title, an invitee list, and a speaker of the current meeting. In this example, no links to previous meetings are provided by the user; therefore, at step 303, calendar analysis program 110 searches one or more previous meetings that have subjects and presentation titles matching those of the current meeting. The one or more previous meetings are searched through searching entries of calendar program 120 and/or database 130. Searching the subjects and the presentation titles is conducted through searching keywords in the subject, the presentation title, or the presentation content of the current meeting. At decision block 305, calendar analysis program 110 determines whether the one or more previous meetings are found. In response to that the one or more previous meetings are found (YES branch of decision block 305), at step 307, calendar analysis program 110 retrieves, from either calendar program 120 or database 130, meeting information of the one or more previous meetings. The meeting information of the one or more previous meetings includes presentation titles, attendee lists, and speakers of the one or more previous meetings. In this example, analysis of the meeting information of the one or more previous meetings and the current meeting is requested by the user. As an example of the analysis, calendar analysis program 110, at step 309, determines how many invitees of the current meeting have viewed presentation documents of the previous meetings. In this example, analysis of presentation documents is requested by the user; thus, at step 311, calendar analysis program 110, acquires presentation documents of the one or more previous meetings and the current meeting. For example, calendar analysis program 110 follows links provided in calendar program 120 to retrieve the presentation documents stored on database 130, or calendar analysis program 110 requests the user to input the presentation documents. At step 313, calendar analysis program 110 compares charts in the presentation documents of the one or more previous meetings with charts in the presentation documents of the current meeting. At step 315, calendar analysis program 110 determines differences between the presentation documents of the one or more previous meetings and the presentation documents of the current meeting. After analysis of the meeting information and presentation documents, calendar analysis program 110, at step 317, presents comparison between the current meeting and the one or more previous meetings.

Table 1 shows an example of a report generated by calendar analysis program 110. In this example, the subject is “Cloud Computing Performance” and the presentation title is “How to Monitor Performance in the Cloud”. The report indicates that a previous meeting and a current meeting have the same subject, same presentation title, and same speaker (Speaker A). The report provides the result of the analysis of the meeting information and shows that 70% of invitees of the current meeting have viewed the presentation at the precious meeting. The report also provides the result of the analysis of presentation documents, and the report indicates that the presentation document of the current meeting has a new chart and otherwise has no differences from the presentation document of the previous meeting. The report provides the organizer or the chairperson with information for making a decision on the current meeting management.

TABLE 1

| Description | Previous Meeting | Current Meeting |
|---|---|---|
| Meeting Date | Mar. 4, 2011 | Jul. 8, 2011 |
| Meeting Subject | Cloud Computing | Cloud Computing |
| | Performance | Performance |
| Presentation | How to Monitor | How to Monitor |
| | Performance in the | Performance in the |
| | Cloud | Cloud |
| Speaker | Speaker A | Speaker A |
| Invitees Having Viewed the | N/A | 14 (70%) |
| Presentation | | |
| Presentation Difference | N/A | Chart 22 (New) |

Referring to FIG. 3, at decision block 319, calendar analysis program 110 makes a decision based on whether the user requests changes to the current meeting. In this example, based on the report, the organizer or the chairperson may rearrange the current meeting, e.g., to change the presentation that has been scheduled. In response to that the organizer or the chairperson rearranges the current meeting (YES branch of decision block 319), calendar analysis program 110, at step 321, receives the changes and makes the changes on calendar program 120.

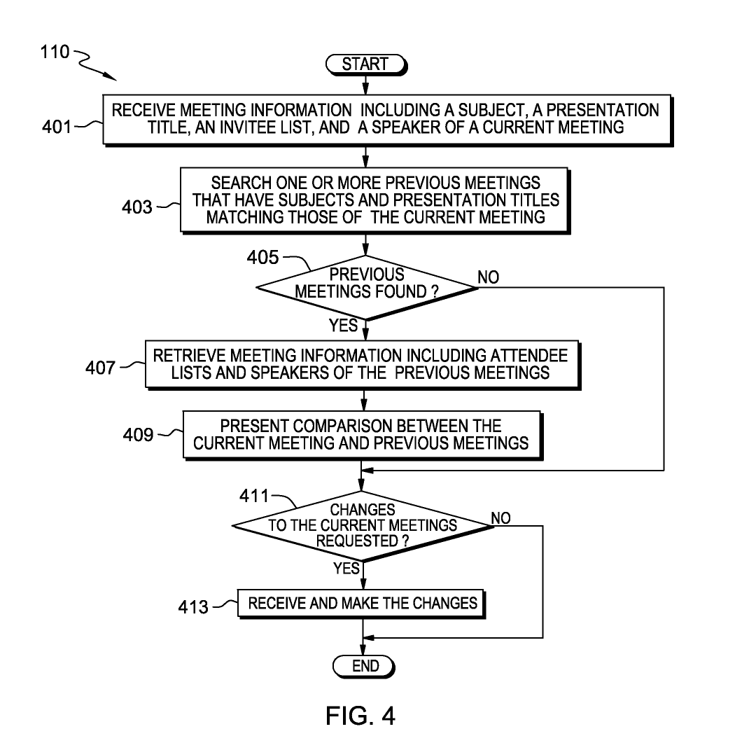

FIG. 4 is a flowchart illustrating a second example of analysis of meeting content and agendas, in accordance with an exemplary embodiment of the present invention. In the second example, calendar analysis program 110 is used by an invitee of a current meeting. At step 401, calendar analysis program 110 receives, from the invitee, meeting information including a subject, a presentation title, an invitee list, and a speaker of the current meeting. In this example, no links to previous meetings are provided by the user; therefore, at step 403, calendar analysis program 110 searches one or more previous meetings that have subjects and presentation titles matching those of the current meeting. At decision block 405, calendar analysis program 110 determines whether the one or more previous meetings are found. In response to that the one or more previous meetings are found (YES branch of decision block 405), at step 407, calendar analysis program 110 retrieves, from either calendar program 120 or database 130, meeting information of the one or more previous meetings. The meeting information of the one or more previous meetings includes presentation titles, attendee lists, and speakers of the one or more previous meetings. In this example, analysis of the meeting information and analysis of presentation documents are not requested by the user. At step 409, calendar analysis program 110 presents comparison between the one or more previous meetings and the current meeting.

Table 2 shows an example of a report generated by calendar analysis program 110. In this example, calendar analysis program 110, through the search at step 403, finds three previous meetings and two matching presentation titles: “How to Write Strong Claims” and “Analyzing Search Results”, under the subject of “Patent Forum”. Table 2 shows that the former presentation title (“How to Write Strong Claims”) is presented by Speaker B at the three previous meetings but by Speaker C at the current meeting. Table 2 also shows that the latter presentation title (Analyzing Search Results) is presented by the same speaker, Speaker D, at the three previous meetings and the current meeting.

TABLE 2

| Description | Previous Meeting | Current Meeting |
|---|---|---|
| Meeting Date | Jul. 9, 2010, Apr. 12, 2011, | Jul. 8, 2011 |
| | Jun. 3, 2011 | |
| Meeting Subject | Patent Forum | Patent Forum |
| Presentation | How to Write Strong | How to Write Strong |
| | Claims | Claims |
| Speaker | Speaker B | Speaker C |
| Presentation | Analyzing Search Results | Analyzing Search Results |
| Speaker | Speaker D | Speaker D |

At decision block 411, calendar analysis program 110 makes a decision based on whether the user requests changes to the current meeting. In this example, based on the report, the invitee may decide to remove the schedule of attending the presentation of the latter title. In response to that the invitee removes the schedule of attending the presentation of the latter title (YES branch of decision block 411), calendar analysis program 110, at step 413, receives the changes from the invitee and makes the changes on calendar program 120.

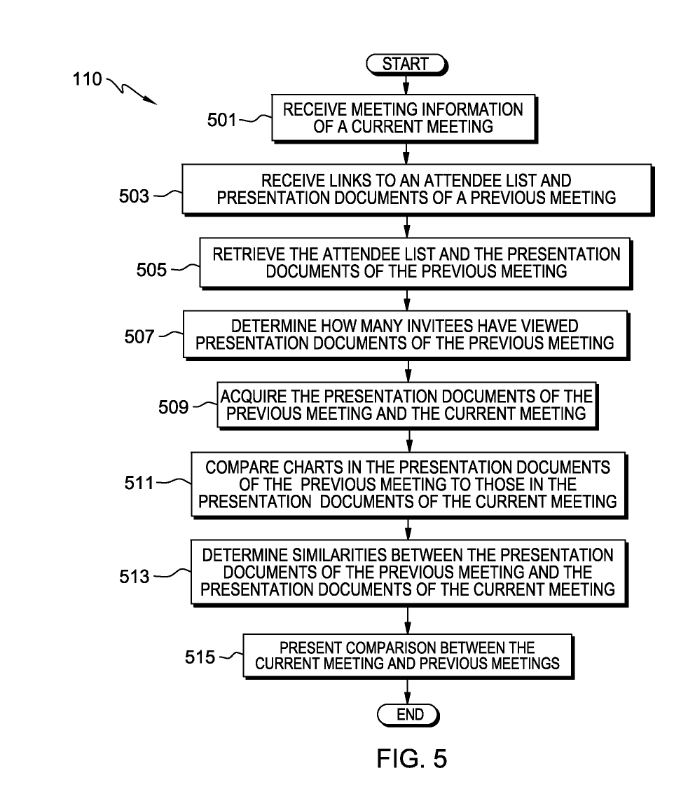

FIG. 5 is a flowchart illustrating a third example of analysis of meeting content and agendas, in accordance with an exemplary embodiment of the present invention. In the third example, calendar analysis program 110 is used by a speaker of a current meeting. Calendar analysis program 110 is used for the speaker to determine how many invitees have viewed material that is similar to the presentation given by the speaker at the current meeting, and also for the speaker to compare a presentation document of the current meeting with a presentation document of a previous meeting. At step 501, calendar analysis program 110 receives, from the speaker, meeting information including an invitee list of a current meeting. At step 503, calendar analysis program 110 receives, from the speaker, links to an attendee list and presentation documents of a previous meeting. At step 505, calendar analysis program 110 retrieves, from calendar program 120 or database 130, the attendee list and the presentation documents of the previous meeting. Calendar analysis program 110, at step 507, determines how many invitees of the current meeting have viewed the presentation documents of the previous meeting. At step 509, calendar analysis program 110 acquires presentation documents of the previous meeting and the current meeting. Calendar analysis program 110 may follow links provided in calendar program 120 or provided by the speaker to retrieve the presentation documents stored on database 130 or other file storage systems. Also, calendar analysis program 110 may also request the user to input or upload the presentation documents. Calendar analysis program 110, at step 511, compares charts in the presentation documents of the previous meeting with charts in the presentation documents of the current meeting. At step 513, calendar analysis program 110 determines similarities between the presentation documents of the previous meeting and the presentation documents of the current meeting. At step 511 and 513, calendar analysis program 110 may use contextual analysis program 150 (shown in FIG. 1) for analysis of the presentation documents. At step 515, calendar analysis program 110 presents comparison between the previous meeting and the current meeting. The comparison shows the similarities between the presentation documents of the previous meeting and the presentation documents of the current meeting. By presenting the comparison, calendar analysis program 110 provides the speaker with information for editing the documents of the current meeting and/or for reorganizing the presentation content. In this example, the user does not make any change to the current meeting; therefore, after step 515, calendar analysis program 110 terminates the operation. Alternatively, calendar analysis program 110 may call one or more programs for editing the presentation documents of the current meeting.

Table 3 shows an example of a report generated by calendar analysis program 110. As shown in Table 3, 42% of invitees of the current meeting have viewed a presentation at the previous meeting. Table 3 shows results of analyzing presentation documents and lists the similarities between a presentation document of the previous meeting and a document of the current meeting.

TABLE 3

| Description | Previous Meeting | Current Meeting |
|---|---|---|
| Meeting Date | Feb. 3, 2011 | Sep. 8, 2011 |
| Meeting Subject | Power Management | Power Management |
| Presentation | Automatically Reducing | Saving Money on Utility |
| | Power Usage | Bills |
| Speaker | Speaker E | Speaker of Current Meeting |
| Invitees Having | N/A | 20 (42%) |
| Viewed the | | |
| Presentation | | |
| Presentation | Chart 2: Smart meters | Chart 3: Intelligent meters |
| Similarities | regulate power usage | regulating usage |
| | Chart 6: Utility company | Chart 3: Obtain meters |
| | provides meters | from the utility company |
| | Chart 9: Turn off power | Chart 5: Turn off power |
| | for short periods | every 15 minutes |
| | Chart 16: Customers sign | Chart 18: Customers sign |
| | up | up |
| | Chart 20: Customer | Chart 19: Customer bill |
| | rebate each month | reduced each month |

FIG. 6 is a diagram illustrating components of a computer device hosting meeting content and agenda analysis system 100 shown in FIG. 1, in accordance with an exemplary embodiment of the present invention. It should be appreciated that FIG. 6 provides only an illustration of one implementation and does not imply any limitations with regard to the environment in which different embodiments may be implemented.

Referring to FIG. 6, the computer device includes communications fabric 600 which provides communications among processor(s) 620, memory 610, tangible storage device(s) 630, network interface(s) 640, and I/O (input/output) interface(s) 650. Memory 610 includes ROM(s) (Read Only Memory) 611, RAM(s) (Random Access Memory) 613, and cache(s) 615.

One or more operating system(s) 631 and one or more computer program(s) 633 reside on one or more computer-readable tangible storage device(s) 630. In the exemplary embodiment, calendar analysis program 110, calendar program 120, database 130, voice to text program 140, and contextual analysis program 150 reside on one or more computer-readable tangible storage device(s) 630 of the computer device. In other embodiments, however, calendar analysis program 110, calendar program 120, database 130, voice to text program 140, and contextual analysis program 150 reside respectively on multiple computer devices which are connected by a network.

The computer device further includes I/O interface(s) 650. I/O interface(s) 650 allow for input and output of data with external device(s) 660 that may be connected to the computer device. The computer device further includes network interface(s) 640 for communications between the computer device and a computer network.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for analysis of meeting content and agendas, the method implemented by a computer system, the method comprising:
receiving meeting information of a first meeting;
searching one or more second meetings matching the first meeting;
retrieving meeting information of the one or more second meetings;
analyzing the meeting information of the first meeting and the meeting information of the one or more second meetings;
acquiring one or more presentation documents of the first meeting and one or more presentation documents of the one or more second meetings;
analyzing the one or more presentation documents of the first meeting and the one or more presentation documents of the one or more second meetings; and
presenting a comparison between the first meeting and the one or more second meetings.

2. The method of claim 1, wherein the meeting information of the first meeting includes an agenda of the first meeting, and wherein the meeting information of the one or more second meetings includes agendas of the one or more second meetings.

3. The method of claim 1, wherein the one or more presentation documents are text files, video files, audio files, or charts.

4. The method of claim 1, further comprising:
receiving from a user changes to the first meeting; and
making the changes on a calendar program on the computer system.

5. The method of claim 1, further comprising:
comparing the one or more presentation documents of the first meeting with the one or more presentation documents of the one or more second meetings; and
determining differences or similarities between the one or more presentation documents of the first meeting and the one or more presentation documents of the one or more second meetings.

6. The method of claim 1, further comprising:
determining how many invitees of the first meeting have viewed the one or more presentation documents of the one or more second meetings.

7. The method of claim 1, wherein searching the one or more second meetings is based on keywords in subjects or presentation titles of the first meeting and the one or more second meetings.

8. A computer program product for analysis of meeting content and agendas, the computer program product comprising:
one or more computer-readable tangible storage devices and program instructions stored on at least one of the one or more computer-readable tangible storage devices, the program instructions comprising:
program instructions to receive meeting information of a first meeting;
program instructions to search one or more second meetings matching the first meeting;
program instructions to retrieve meeting information of the one or more second meetings;
program instructions to analyze the meeting information of the first meeting and the meeting information of the one or more second meetings;
program instructions to acquire one or more presentation documents of the first meeting and one or more presentation documents of the one or more second meetings;
program instructions to analyze the one or more presentation documents of the first meeting and the one or more presentation documents of the one or more second meetings; and
program instructions to present a comparison between the first meeting and the one or more second meetings.

9. The computer program product of claim 8, wherein the meeting information of the first meeting includes an agenda of the first meeting, and wherein the meeting information of the one or more second meetings includes agendas of the one or more second meetings.

10. The computer program product of claim 8, wherein the one or more presentation documents are text files, video files, audio files, or charts.

11. The computer program product of claim 8, further comprising:
program instructions to receive from a user changes to the first meeting; and
program instructions to make the changes on a calendar program on a computer system.

12. The computer program product of claim 8, further comprising:
program instructions to compare the one or more presentation documents of the first meeting with the one or more presentation documents of the one or more second meetings; and
program instructions to determine differences or similarities between the one or more presentation documents of the first meeting and the one or more presentation documents of the one or more second meetings.

13. The computer program product of claim 8, further comprising:
program instructions to determine how many invitees of the first meeting have viewed the one or more presentation documents of the one or more second meetings.

14. The computer program product of claim 8, wherein searching the one or more second meetings is based on keywords in subjects or presentation titles of the first meeting and the one or more second meetings.

15. A computer system for analysis of meeting content and agendas, the computer system comprising:
one or more processors, one or more computer-readable tangible storage devices, and program instructions stored on at least one of the one or more computer-readable storage devices for execution by at least one of the one or more processors, the program instructions comprising:
program instructions to receive meeting information of a first meeting;
program instructions to search one or more second meetings matching the first meeting;
program instructions to retrieve meeting information of the one or more second meetings;
program instructions to analyze the meeting information of the first meeting and the meeting information of the one or more second meetings;
program instructions to acquire one or more presentation documents of the first meeting and one or more presentation documents of the one or more second meetings;
program instructions to analyze the one or more presentation documents of the first meeting and the one or more presentation documents of the one or more second meetings; and
program instructions to present a comparison between the first meeting and the one or more second meetings.

16. The computer system of claim 15, wherein the meeting information of the first meeting includes an agenda of the first meeting, wherein the meeting information of the one or more second meetings includes agendas of the one or more second meetings, wherein the one or more presentation documents are text files, video files, audio files, or charts.

17. The computer system of claim 15, further comprising:
program instructions to receive from a user changes to the first meeting; and
program instructions to make the changes on a calendar program on the computer system.

18. The computer system of claim 15, further comprising:
program instructions to compare the one or more presentation documents of the first meeting with the one or more presentation documents of the one or more second meetings; and
program instructions to determine differences or similarities between the one or more presentation documents of the first meeting and the one or more presentation documents of the one or more second meetings.

19. The computer system of claim 15, further comprising:
program instructions to determine how many invitees of the first meeting have viewed the one or more presentation documents of the one or more second meetings.

20. The computer system of claim 15, wherein searching the one or more second meetings is based on keywords in subjects or presentation titles of the first meeting and the one or more second meetings.
